(19) United States
(12) Patent Application Publication
(10) Pub. No.: US 2014/0246994 A1
(43) Pub. Date: Sep. 4, 2014

(54) ELECTRIC MOTOR WITH ONBOARD INVERTER

(71) Applicant: MOTIVE S.R.L., Castenedolo (IT)

(72) Inventors: Guiseppe Corsini, Nave (IT); Giorgio Bosio, Nuvolento (IT)

(73) Assignee: MOTIVE S.R.L., Castenedolo (IT)

(21) Appl. No.: 14/351,402

(22) PCT Filed: Jul. 23, 2013
(86) PCT No.: PCT/IB2013/056031

§ 371 Date: Apr. 11, 2014

(30) Foreign Application Priority Data
Jul. 24, 2012 (IT) VR2012A000155

(51) Int. Cl. H02P 29/00

(52) U.S. Cl. CPC H02P 29/00
USPC 318/16

(57) ABSTRACT

An electric motor with onboard inverter, comprising a motor body which is associated with at least one output shaft and supports an inverter for adjusting the speed of the output shaft; the electric motor comprises a remote control unit of the wireless type for the inverter.

The present invention relates to an electric motor and, specifically, to an electric motor with onboard inverter.

Electric motors, typically three-phase asynchronous motors, with onboard inverters are known and widely used for various applications.

Normally, onboard inverters are controlled by way of buttons or rotary controls which are supported directly by the inverter or by way of a remote control panel which is connected to the inverter by electrical connection cables or wires.

Typically, the inverters on board such types of motors make it possible, in addition to adjusting the output speed of the drive shaft, to set some operating parameters of the electric motor.

In particular, by operating the inverter it is possible to set, for example, the frequency of operation of the electric motor, its operating current, the acceleration and deceleration ramps, characteristics relating to optional external transducers for controlling the speed, the use of filters for suitability of operation in a residential environment, the use of the inverter as a master inverter for driving inverters associated with other electric motors, saving of the operating modes of the electric motor, etc.

A drawback of the solution involving control buttons supported directly by the motor is constituted by the difficulty of operating the controls if the motor is positioned in areas that are not easily accessible.

On the other hand, with motors with onboard inverters which can be controlled by way of a remote control panel, there is a certain inconvenience if it is necessary to move the motor.

The aim of the present invention is to make available an electric motor with onboard inverter which is capable of eliminating the above-mentioned drawbacks.

Within this aim, an object of the present invention is to provide an electric motor with onboard inverter which is very simple in structure and which is low-cost, so as to make its use advantageous from an economic viewpoint as well.

This aim and these and other objects which will become more apparent hereinafter are all achieved by an electric motor with onboard inverter according to claim 1.

Further characteristics and advantages of the invention will become more apparent from the description of some preferred, but not exclusive, embodiments of an electric motor with onboard inverter, which are illustrated by way of non-limiting example in the accompanying drawings wherein:

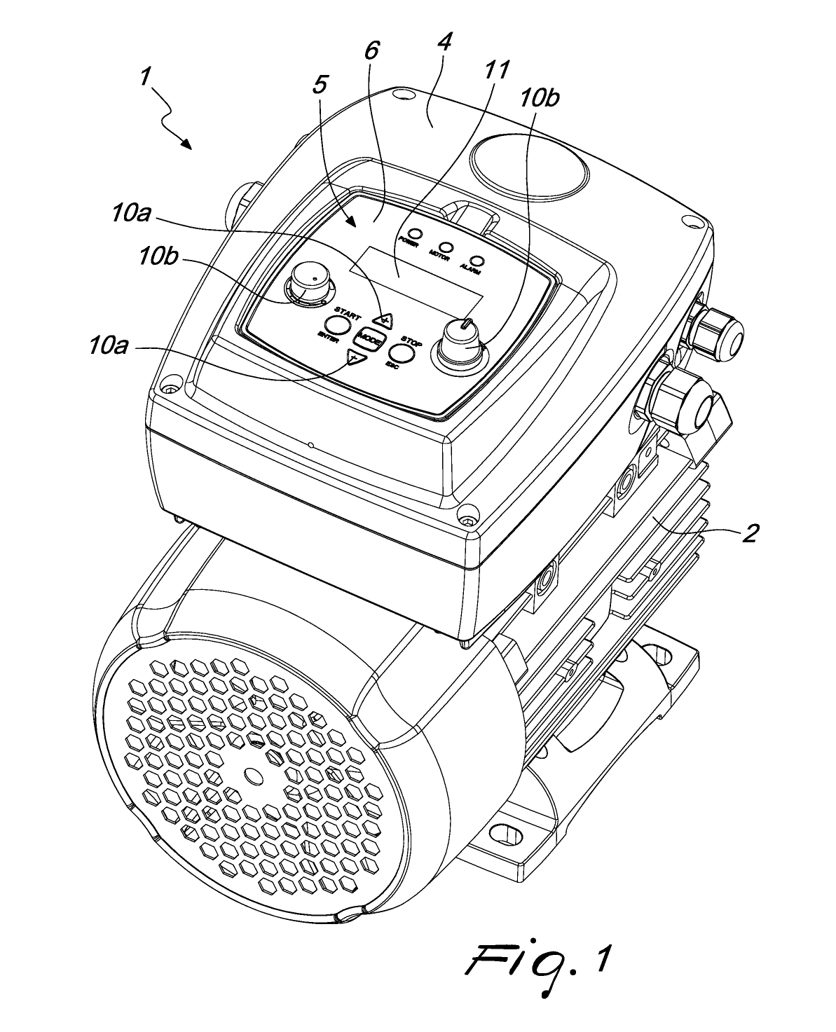

FIG. 1 is a perspective view of the electric motor according to the invention;

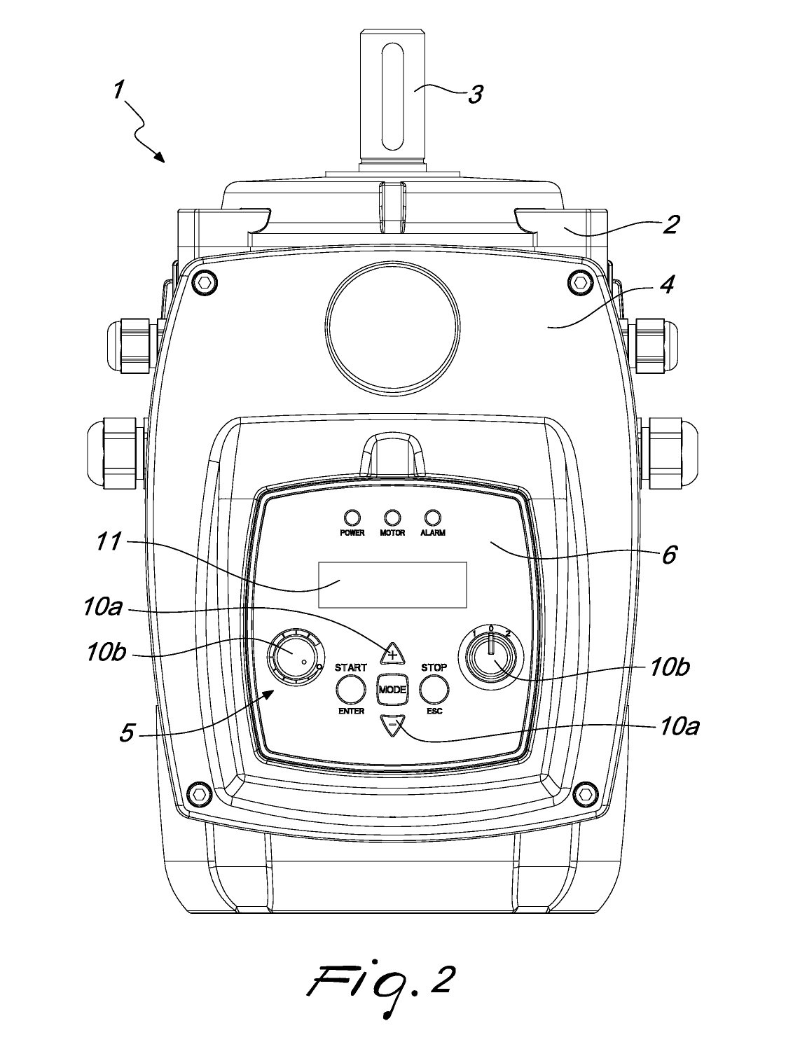

FIG. 2 is a plan view of the electric motor;

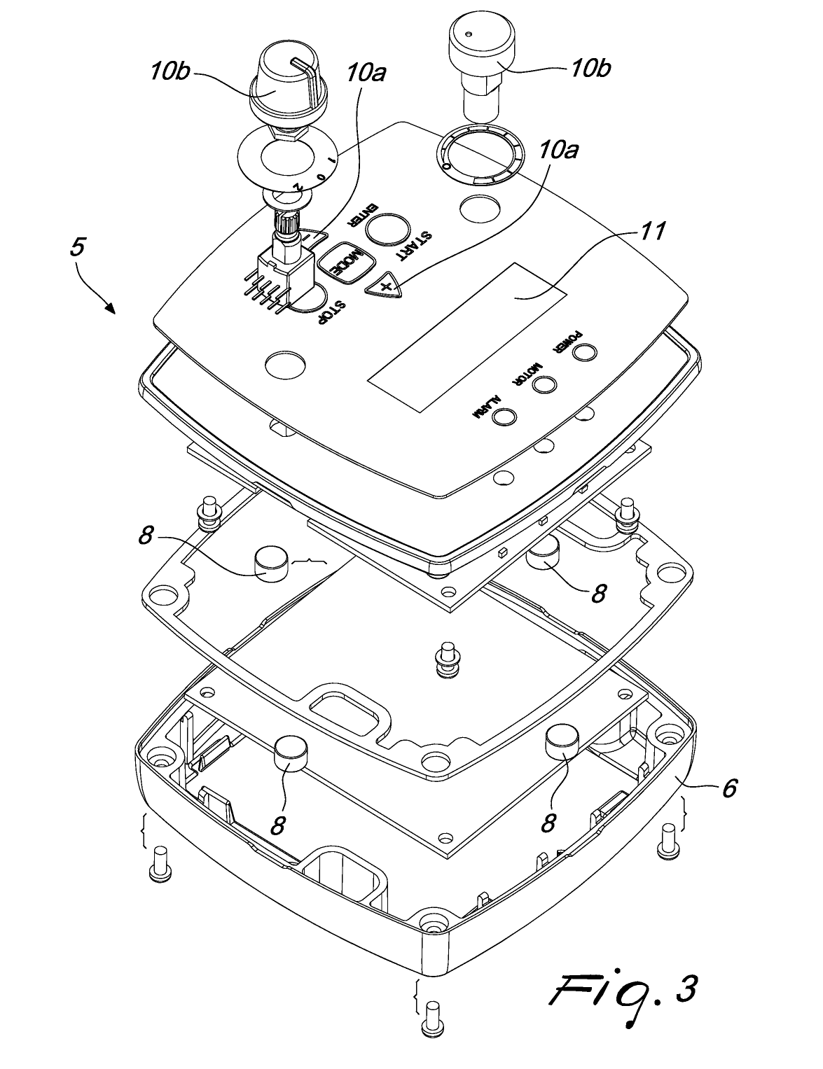

FIG. 3 is an exploded perspective view of the remote control means of the wireless type;

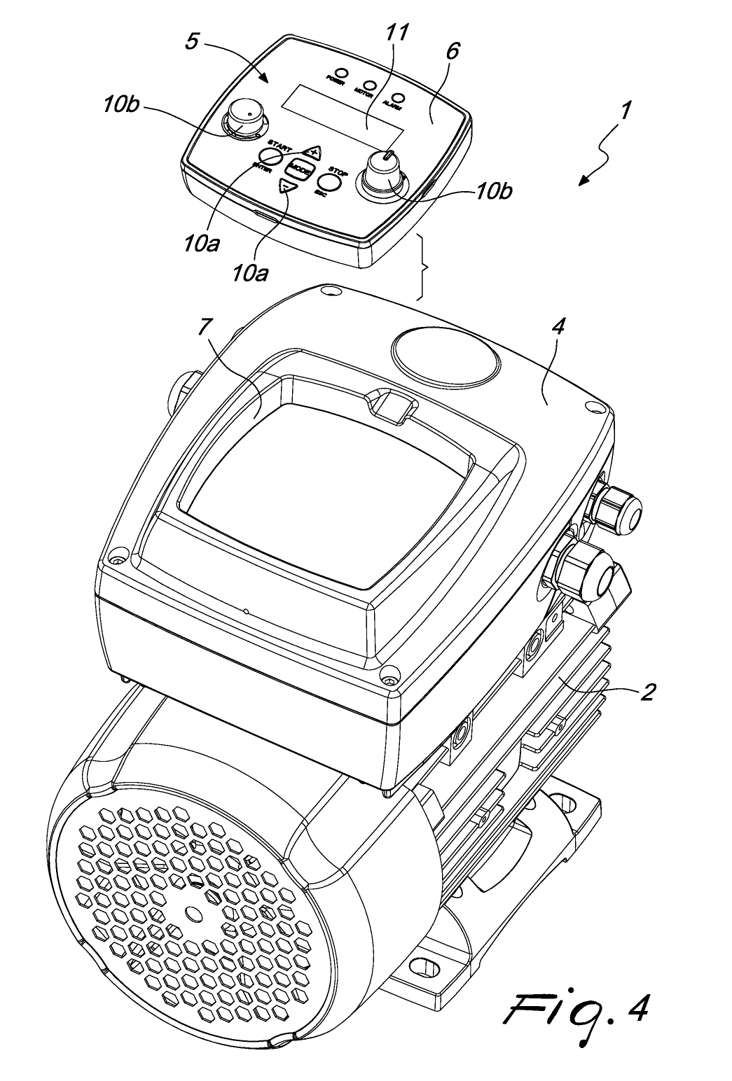

FIG. 4 is another perspective view of the electric motor and, separate, the remote control means of the wireless type.

In the embodiments illustrated, individual characteristics shown in relation to specific examples may in reality be interchanged with other, different characteristics, existing in other embodiments.

With reference to the figures, the present invention relates to an electric motor, generally indicated with the reference numeral 1, with onboard inverter.

The electric motor 1 comprises a motor body 2 which is associated with at least one output shaft 3 and supports an inverter 4 for adjusting the speed of the output shaft 3.

Advantageously, the electric motor 1 comprises a three-phase asynchronous motor.

According to the present invention, the electric motor 1 comprises remote control means of the wireless type 5 of the inverter 4.

Conveniently, the remote control means of the wireless type 5 comprise a remote control 6.

Preferably, the remote control means of the wireless type 5 are adapted to set one or more operating parameters selected from the group that comprises:

the frequency of operation of the electric motor;

the current of the electric motor;

the acceleration and deceleration ramps;

characteristics relating to an optional external transducer for controlling the speed;

the use of the inverter as the master inverter for driving inverters associated with other electric motors;

saving of the operating modes of the electric motor.

According to a preferred embodiment, the remote control means of the wireless type 5 are powered by at least one rechargeable battery.

In this regard, the electric motor 1 is associated or provided with a device for recharging the rechargeable battery or batteries of the remote control means of the wireless type 5.

Advantageously the inverter 4 comprises a receptacle 7 for the remote control 6.

According to a preferred embodiment, both the receptacle 7 and the remote control 6 have a respective outer containment enclosure that is watertight.

Preferably, the recharging device is defined on the inverter 4 and, specifically, is arranged at the receptacle 7.

Conveniently, the recharging device comprises an induction-type battery charger.

In this manner, the rechargeable battery or batteries of the remote control 6 are recharged whenever the remote control 6 is stowed in the receptacle 7; in this regard, the choice of the induction-type battery charger makes it possible to provide both the receptacle 7 and the remote control 6 without contacts or electrical connectors and this ensures, evidently, an effective watertight seal of the inverter 4 and of the remote control means of the wireless type 5.

According to a further aspect, the remote control means of the wireless type 5 support at least one magnet element 8 in order to enable the user to detachably couple it, in a manner that is extremely practical and effective, to metallic supporting bodies which are generally present in the environments in which the electric motor 1 is installed.

Finally, it should be noted that the remote control means of the wireless type 5 can be provided with actuation elements that can be constituted by buttons 10a or by rotary controls 10b.

Advantageously, the actuation elements present on the remote control means of the wireless type 5 can be constituted both by buttons 10a and by rotary controls 10b. In this manner, according to practical requirements or to user preference, it can be decided whether to use the buttons 10a or the rotary controls 10b.

Conveniently, the remote control means of the wireless type 5 can be associated with a display 11 and, optionally, with indicator lights.

The use of an electric motor 1 according to the invention is evident from the foregoing description.

In particular, it is possible, thanks to the remote control means of the wireless type 5, to control the inverter 4 arranged aboard the electric motor 1 remotely and without, necessarily, moving to the remote control panel.

Furthermore, thanks to the induction-type battery charger, it is possible to ensure the seal against water and humidity both of the remote control 6 and of the inverter 4 since no electrical connectors or contacts need to be provided.

All the characteristics of the invention, indicated above as advantageous, convenient or similar, may also be missing or be substituted by equivalent characteristics.

The invention, thus conceived, is susceptible of numerous modifications and variations, all of which are within the scope of the appended claims.

In practice it has been found that in all the embodiments the invention has achieved the intended aim and objects.

In practice the materials employed, as well as the dimensions and the contingent shapes, may be any according to requirements.

Moreover, all the details may be substituted by other, technically equivalent elements.

The disclosures in Italian Patent Application No. VR2012A000155, from which this application claims priority are incorporated herein by reference.

1-11. (canceled)

12. An electric motor with onboard inverter, comprising a motor body which is associated with at least one output shaft and supports an inverter for adjusting the speed of said at least one output shaft, further comprising remote control means of the wireless type for said inverter.

13. The electric motor according to claim 12, wherein said remote control means of the wireless type are adapted to set one or more operating parameters selected from the group that comprises:
a frequency of operation of said electric motor;
a current of said electric motor;
an acceleration and deceleration ramps;
characteristics relating to an optional external transducer for controlling the speed;
use of said inverter as the master inverter for driving inverters associated with other electric motors;
saving of the operating modes of the electric motor.

14. The electric motor according to claim 12, further comprising a three-phase asynchronous motor.

15. The electric motor with onboard inverter according to claim 12, wherein said remote control means of the wireless type comprise a remote control.

16. The electric motor with onboard inverter according to claim 12, wherein said remote control means of the wireless type are powered by at least one rechargeable battery.

17. The electric motor according to claim 15, further comprising a device for recharging said at least one rechargeable battery.

18. The electric motor according to claim 17, wherein said inverter defines a receptacle for said remote control, said receptacle and said remote control being watertight.

19. The electric motor according to claim 18, wherein said receptacle is associated with said recharging device.

20. The electric motor according to claim 17, wherein said recharging device comprises an induction-type battery charger.

21. The electric motor according to claim 12, wherein said remote control means of the wireless type support at least one magnet element adapted to enable the user to detachably couple said remote control means of the wireless type to metallic supporting bodies.

22. The electric motor according to claim 12, wherein said remote control means of the wireless type have actuation elements which comprise buttons and/or rotary controls.
